(19) United States
(12) Patent Application Publication
(10) Pub. No.: US 2023/0229668 A1
(43) Pub. Date: Jul. 20, 2023

(54) COMPUTER TECHNOLOGY FOR PERFORMING DATA TRANSFORMATION USING VISUALIZATION DIAGRAMS

(71) Applicant: International Business Machines Corporation, Armonk, NY (US)

(72) Inventors: Zhe Shao, Xian (CN); Xiao Bin Sun, Xian (CN); Chun Lei Xu, Xian (CN); Heng Tang, Xian (CN); Fan Bai, Xian (CN)

(21) Appl. No.: 17/648,322

(22) Filed: Jan. 19, 2022

(51) Int. Cl. G06F 16/26; G06F 16/25

(52) U.S. Cl. CPC G06F 16/26; G06F 16/258

(57) ABSTRACT

Computer technology for transforming data in a data store (for example, a database) through a user interface (UI) in the form of a visualization diagram having human understandable visual information. A user interacts with the visualization diagram to effect desired transformations in the data of the data store.

### BACKGROUND

The present invention relates generally to the field of user interfaces for performing data transformation, and also to computer generated visualization diagrams.

Data transformation is a very common step in data analysis and machine learning type computer processes. Traditional data transformation is done by defining either transform expressions or executable scripts (SQL (structured query language), DSL (domain specific language), etc.) directly or even with UI widgets, then applying the transformation scripts to target data set. Data visualization is primarily used along with data transformation in data preparation phase. The general (3-step iteration) process of data preparation is: (i) visualize data characteristics; (ii) transform data based on data characteristics gained from step; and (iii) re-visualize data and check the transformation result.

### SUMMARY

According to an aspect of the present invention, there is a method, computer program product and/or system that performs the following operations (not necessarily in the following order): (i) receiving a data store including a plurality of data values; (ii) generating an initial visualization diagram representing at least some of the data values in the data store; (iii) displaying the initial visualization diagram to a user; (iv) receiving, from the user, a first user input indicative of a desired first transformation of the data in the data store; and (v) responsive to the receipt of the first user input, performing a first transformation of the data in the data store.

### BRIEF DESCRIPTION OF THE DRAWINGS

FIG. 1 is a block diagram of a first embodiment of a system according to the present invention;

FIG. 2 is a flowchart showing a first embodiment method performed, at least in part, by the first embodiment system; and

FIG. 3 is a block diagram showing a machine logic (for example, software) portion of the first embodiment system; and

FIG. 4 is a screen shot of a scatter plot type visualization diagram.

### DETAILED DESCRIPTION

This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product at any possible technical detail level of integration. The computer program product may include a computer readable storage medium (or media) having computer readable program instructions thereon for causing a processor to carry out aspects of the present invention. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

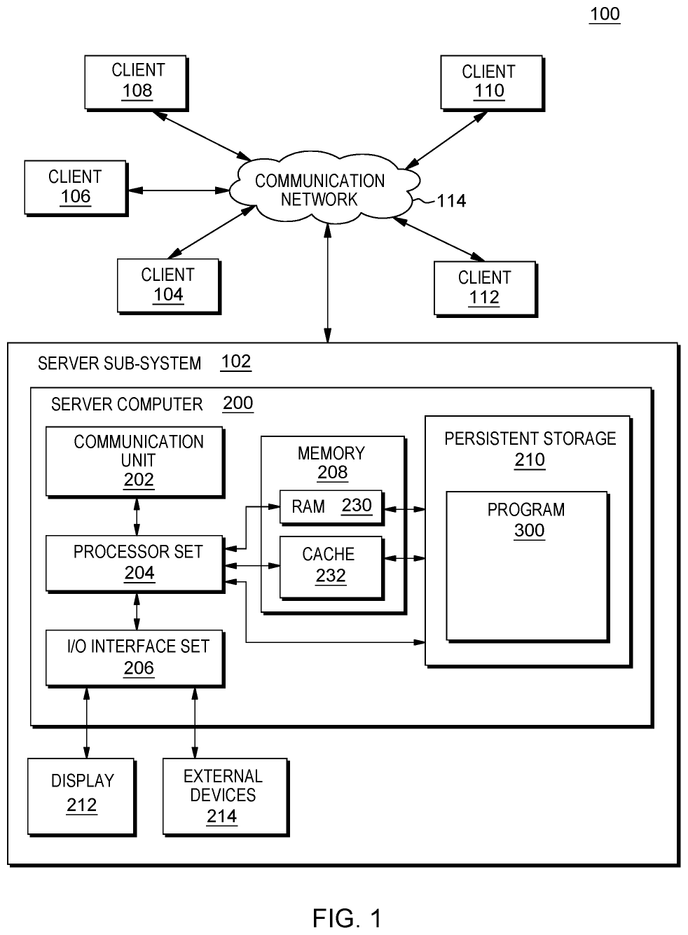

As shown in FIG. 1, networked computers system 100 is an embodiment of a hardware and software environment for use with various embodiments of the present invention. Networked computers system 100 includes: server subsystem 102 (sometimes herein referred to, more simply, as subsystem 102); client subsystems 104, 106, 108, 110, 112; and communication network 114. Server subsystem 102 includes: server computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

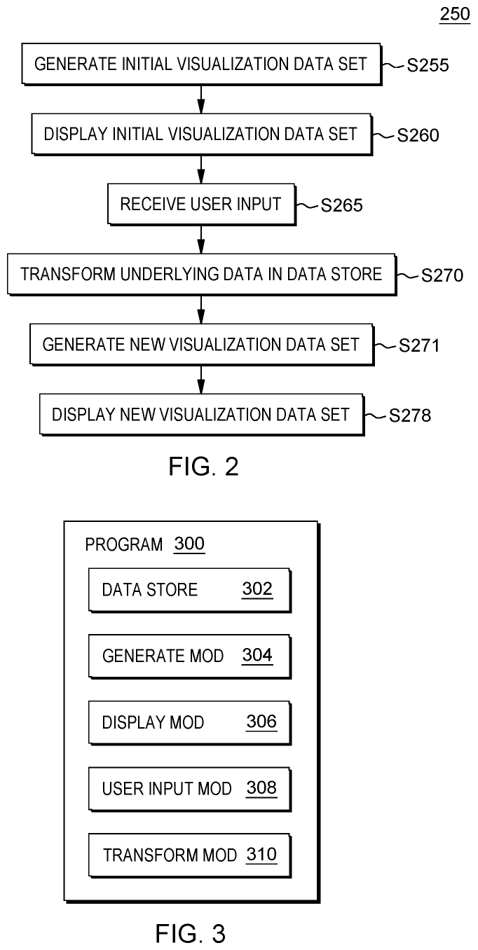

As shown in FIG. 1, networked computers system 100 is an environment in which an example method according to the present invention can be performed. As shown in FIG. 2, flowchart 250 shows an example method according to the present invention. As shown in FIG. 3, program 300 performs or control performance of at least some of the method operations of flowchart 250. This method and associated software will now be discussed, over the course of the following paragraphs, with extensive reference to the blocks of FIGS. 1, 2 and 3.

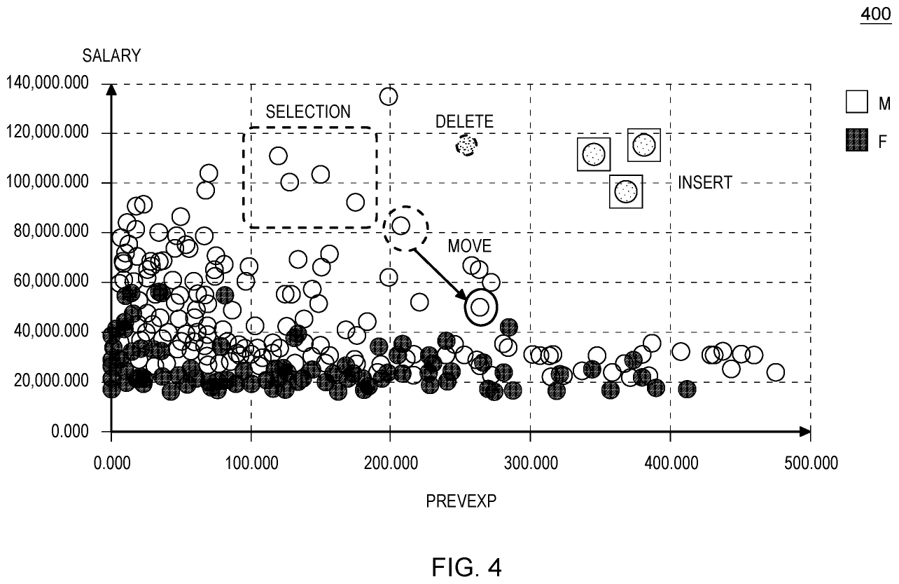

Processing begins at operation S255, where data store 302 is received, with the data store including a plurality of data values. The data values for this example are shown in scatter plot type visualization diagram 400 of FIG. 4.

Processing proceeds to operation S260, where generation module (“mod”) 304 and display mod 306 generate and display an initial visualization diagram representing at least some of the data values in the data store. This is shown at diagram 400. In this example, the user's device is part of client subsystem 104.

Processing proceeds to operation S265, where user input mod 308 receives, from the user, a first user input indicative of a desired first transformation of the data in the data store. Some examples of this kind of user input are shown in diagram 400 (see, delete, insertion and move operations). The user input is received from client subsystem 104 and through communication network 114.

Processing proceeds to operation S270, where, responsive to the receipt of the first user input, transform mod 310 performs a first transformation of the data in the data store. As shown in diagram 400, these transformations may be of types such as move (that is, change some of the data value(s) in the data store, delete and insert).

Processing proceeds to operation S271, where generate mod 304 generates a new visualization diagram representing at least some of the data values in the data store as transformed by the performance of the first transformation.

Processing proceeds to operation S278, where display mod 306 displays the new visualization diagram to the user at client subsystem 104. Although not shown in flow chart 250, processing may loop back to operation S265 so that the user may perform additional transformations on the data store by further interactions though the user interface in the form of the visualization diagram. Some types of visualization diagrams include: bar chart, scatter plot (see FIG. 4), line graph and pie chart.

### III. Further Comments and/or Embodiments

Some embodiments of the present invention recognize one, or more, of the following facts, potential problems and/or potential areas for improvement with respect to the current state of the art: (i) a user needs to have fundamental scripts programming skills or be familiar with various data analyzing tools to perform desired data transformation tasks; and/or (ii) the 3-step iteration (visualize-transform-visualize, see Background section) has lower efficiency than a “what you see is what you get” (WYSIWY) style transformation.

Some embodiments of the present invention may include one, or more, of the following operations, features, characteristics and/or advantages: (i) an interactive data transformation solution; (ii) perform interactive data transformations with visualization chart elements; (iii) WYSIWY style transformation, operating the visualizations and see the result in nearly real-time; (iv) allows a user directly operating the visualization result to perform desired data transformation; (v) extracts data characteristics conveyed by each type of visualization; (vi) defines UI (user interface) operations and corresponding data transformation actions; and/or (vii) real-time visualization sync with data transformation.

Some embodiments of the present invention may include one, or more, of the following operations, features, characteristics and/or advantages: (i) extracts data characteristics conveyed by each type of visualization; (ii) each type of visualization demonstrates a given data set from different dimensions; (iii) for example, scatter plot shows the distribution relation of two continuous variables and each data point can convey the exact x and y value, while a bar chart usually shows the frequencies of discrete variables and each bar shows the exact frequency value; (iv) define UI operation and the underlying data transformation action; (v) with the visualization result, machine logic defines series operation of the visualization elements, and maps the UI operations to underlying data transformation actions; (vi) for example, given a scatter plot, a user can instruct the computer system to Move, Delete, Select data points; (vii) these operation can be easily be translated to following: change the data point value, delete data points, filter or filter out selected points; and/or (viii) users can fill in data by adding new points in the visualization.

Some embodiments of the present invention may include one, or more, of the following operations, features, characteristics and/or advantages: (i) real-time visualization sync with data transformation; (ii) with the interactive UI operation, each operation is translated to a specific data operation and applied to the source data set in real-time, the visualization reflects the changed data set simultaneously; and/or (iii) improves the experience and efficiency of 3-step iteration (see, discussion in Background section).

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above — similar cautions apply to the term “embodiment.”

And/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

Set of thing(s): does not include the null set; “set of thing(s)” means that there exist at least one of the thing, and possibly more; for example, a set of computer(s) means at least one computer and possibly more.

Virtualized computing environments (VCEs): VCEs can be stored as “images.” A new active instance of the VCE can be instantiated from the image. Two types of VCEs are virtual machines and containers. A container is a VCE that uses operating-system-level virtualization. This refers to an operating system feature in which the kernel allows the existence of multiple isolated user-space instances, called containers. This isolated user-space instances may look like real computers from the point of view of programs running in them. A computer program running on an ordinary operating system can see all resources (connected devices, files and folders, network shares, CPU power, quantifiable hardware capabilities) of that computer. However, programs running inside a container can only see the container's contents and devices assigned to the container.

Cloud computing system: a computer system that is distributed over the geographical range of a communication network(s), where the computing work and/or computing resources on the server side are primarily (or entirely) implemented by VCEs (see definition of VCEs in previous paragraph). Cloud computing systems typically include a cloud orchestration module, layer and/or program that manages and controls the VCEs on the server side with respect to instantiations, configurations, movements between physical host devices, terminations of previously active VCEs and the like.

What is claimed is:

1. A computer-implemented method (CIM) comprising:
receiving a data store including a plurality of data values;
generating an initial visualization diagram representing at least some of the data values in the data store;
displaying the initial visualization diagram to a user;
receiving, from the user, a first user input indicative of a desired first transformation of the data in the data store; and
responsive to the receipt of the first user input, performing a first transformation of the data in the data store.

2. The CIM of claim 1 further comprising:
generating a new visualization diagram representing at least some of the data values in the data store as transformed by the performance of the first transformation; and
displaying the new visualization diagram to the user.

3. The CIM of claim 1 wherein the initial visualization diagram is one of the following types: bar chart, pie chart, line graph or scatter plot.

4. The CIM of claim 1 wherein the first transformation is a change in data values of at least some of the data value(s) in the data store.

5. The CIM of claim 1 wherein the first transformation is an insertion of at least one data value into the data store.

6. The CIM of claim 1 wherein the first transformation is a deletion of at least one data value in the data store.

7. A computer program product (CPP) comprising:
a set of storage device(s); and
computer code stored collectively in the set of storage device(s), with the computer code including data and instructions to cause a processor(s) set to perform at least the following operations:
receiving a data store including a plurality of data values,
generating an initial visualization diagram representing at least some of the data values in the data store,
displaying the initial visualization diagram to a user,
receiving, from the user, a first user input indicative of a desired first transformation of the data in the data store, and
responsive to the receipt of the first user input, performing a first transformation of the data in the data store.

8. The CPP of claim 7 wherein the computer code further includes instructions for causing the processor(s) set to perform the following operation(s):
generating a new visualization diagram representing at least some of the data values in the data store as transformed by the performance of the first transformation; and
displaying the new visualization diagram to the user.

9. The CPP of claim 7 wherein the initial visualization diagram is one of the following types: bar chart, pie chart, line graph or scatter plot.

10. The CPP of claim 7 wherein the first transformation is a change in data values of at least some of the data value(s) in the data store.

11. The CPP of claim 7 wherein the first transformation is an insertion of at least one data value into the data store.

12. The CPP of claim 7 wherein the first transformation is a deletion of at least one data value in the data store.

13. A computer system (CS) comprising:
a processor(s) set;
a set of storage device(s); and
computer code stored collectively in the set of storage device(s), with the computer code including data and instructions to cause the processor(s) set to perform at least the following operations:
receiving a data store including a plurality of data values,
generating an initial visualization diagram representing at least some of the data values in the data store,
displaying the initial visualization diagram to a user,
receiving, from the user, a first user input indicative of a desired first transformation of the data in the data store, and
responsive to the receipt of the first user input, performing a first transformation of the data in the data store.

14. The CS of claim 13 wherein the computer code further includes instructions for causing the processor(s) set to perform the following operation(s):
generating a new visualization diagram representing at least some of the data values in the data store as transformed by the performance of the first transformation; and
displaying the new visualization diagram to the user.

15. The CS of claim 13 wherein the initial visualization diagram is one of the following types: bar chart, pie chart, line graph or scatter plot.

16. The CS of claim 13 wherein the first transformation is a change in data values of at least some of the data value(s) in the data store.

17. The CS of claim 13 wherein the first transformation is an insertion of at least one data value into the data store.

18. The CS of claim 13 wherein the first transformation is a deletion of at least one data value in the data store.
